(19) United States
(12) Patent Application Publication
(10) Pub. No.: US 2014/0023008 A1
(43) Pub. Date: Jan. 23, 2014

(54) METHOD FOR ESTABLISHING A DEVICE-TO-DEVICE LINK CONNECTION AND SCHEDULING FOR DEVICE-TO-DEVICE COMMUNICATION AND TERMINAL RELAYING

(71) Applicants: Jae-Young Ahn, Daejeon (KR); Tae Gyun Noh, Daejeon (KR); Young Jo Ko, Daejeon (KR)

(72) Inventors: Jae-Young Ahn, Daejeon (KR); Tae Gyun Noh, Daejeon (KR); Young Jo Ko, Daejeon (KR)

(21) Appl. No.: 13/976,509

(22) PCT Filed: Dec. 27, 2011
(86) PCT No.: PCT/KR11/10172

§ 371 Date: Oct. 4, 2013

(30) Foreign Application Priority Data
Dec. 27, 2010 (KR) 10-2010-0135215

(51) Int. Cl. H04L 5/00

(52) U.S. Cl. CPC H04L 5/006
USPC 370/329

(57) ABSTRACT

Disclosed is a method for establishing a device-to-device link connection and scheduling for device-to-device communication and terminal relaying. The method for operating a terminal according to the present invention comprises the following steps: receiving information on the establishment of a D2D link; reporting a state of a D2D buffer of the D2D link to a base station; and receiving information on the D2D link resource allocation based on the report on the D2D buffer state. The scheduling method for D2D communication according to the present invention enables dynamic scheduling to be performed on a subframe unit basis, and enables semi-continuous scheduling for continuous data transmission for a D2D communication link.

### TECHNICAL FIELD

The present invention relates to direct device-to-device (D2D) communication and user equipment (UE) relaying, and more particularly to a connection configuration and scheduling method of a D2D link for performing direct D2D communication and UE relaying.

### BACKGROUND ART

Direct D2D communication refers to communication in which direct data transmission and reception is performed between two adjacent terminals without the data passing through a base station. That is, the two terminals act as source and destination of the data to perform communication, respectively.

Direct D2D communication may be performed using unlicensed bands such as Bluetooth or wireless LAN such as IEEE802.11. However, it is difficult to provide a scheduled and controlled service in the communication using the unlicensed band. In particular, performance may be rapidly deteriorated due to interference.

On the other hand, in the case of direct D2D communication provided by the wireless communication system using licensed bands or TV white space bands managed in an environment where inter-system interference is controlled, quality of service (QoS) can be supported, frequency use efficiency can be enhanced through frequency reuse, and a communication-enabled distance can be increased.

Meanwhile, UE relaying communication refers to communication in which a nearby terminal (terminal B) having a good link characteristic with a nearby base station, that is, located closer to the base station or located out of a shaded area, relays data between terminal A and the base station in order to increase the transmission capacity of the terminal (terminal A) located at a cell boundary or the shaded area. In this case, terminal A may act as the source and/or destination of data.

The UE relaying can improve the transmission capacity of the terminal located at the cell boundary and can enhance the frequency use efficiency of the entire cell through the frequency reuse.

In this case, a D2D link is required in common with both the direct D2D communication and the UE relaying communication. The D2D link is a link in which terminals belonging to the same cell or other cells directly exchange data without the data passing through a network in cellular communication.

Here, only the D2D link is created between two terminals in the case of direct D2D communication, and a cellular link between the base station and the relay terminal (terminal B) and the D2D link between the relay terminal (terminal B) and the end terminal (terminal A) are created in the case of UE relaying communication.

In order to apply the direct D2D communication described above to the current cellular communication system, a method of setting a D2D link connection for direct D2D communication and scheduling transmission and reception is required. In addition, in order to apply the UE relaying communication described above to the current cellular communication system, a method of setting a D2D link connection between a terminal acting as a relay and a counterpart terminal and scheduling transmission and reception is required.

### DISCLOSURE

### Technical Problem

An object of the present invention is to provide a method of operating a base station as a connection configuration and scheduling method for dynamic scheduling of a D2D link.

Another object of the present invention is to provide a method of operating a terminal as a connection configuration and scheduling method for dynamic scheduling of a D2D link.

Still another object of the present invention is to provide a method of operating a base station as a connection configuration and scheduling method for Semi-Persistent Scheduling (SPS) of a D2D link.

Yet another object of the present invention is to provide a method of operating a terminal as a connection configuration and scheduling method for SPS of a D2D link.

### Technical Solution

According to an example for achieving the object of the present invention described above, there is provided a method of operating a base station for connection configuration and scheduling for dynamic scheduling of a device-to-device (D2D) link, which includes: performing connection configuration of the D2D link; receiving a D2D buffer status report from a first terminal that is a transmission terminal in the D2D link; allocating D2D link resources based on the D2D buffer status report and providing resource allocation information; and receiving channel state information of the D2D link measured by a second terminal that is a reception terminal in the D2D link.

Here, providing the D2D link resource allocation information may include providing the resource allocation information using separate Downlink Control Information (DCI) for each of transmission and reception allocation information of each of unidirectional links forming the D2D link in which the first and second terminals participate, and using unique identifiers of the respective first and second terminals, or providing the resource allocation information using a D2D-radio network temporary identifier (RNTI) for the D2D link. In this case, providing the resource allocation information using the unique identifiers of the respective first and second terminals may include changing a payload size of the DCI or including discrimination information within the DCI in order to determine whether the resource allocation information is one for the D2D link or one for a cellular link and whether the resource allocation information is transmission allocation information or reception allocation information for the D2D link. In this case, providing the resource allocation information using the D2D-RNTI for the D2D link may include varying the D2D-RNTI with respect to each of the transmission allocation information and the reception allocation information, changing a payload size of the DCI, or including discrimination information within the DCI in order to determine whether the resource allocation information is transmission allocation information or reception allocation information.

Here, providing the D2D link resource allocation information may include providing the resource allocation information by using one DCI for each of unidirectional links forming the D2D link in which the first and second terminals participate, and by providing two D2D-RNTIs common to the first and second terminals participating in the D2D link to each of the first and second terminals, providing one D2D-RNTI common to the first and second terminals participating in the D2D link to each of the first and second terminals and changing a payload size of the DCI, or including discrimination information within the DCI in order to determine to which direction the D2D link resource allocation information is directed between two D2D links.

Here, providing the D2D link resource allocation information may include providing the resource allocation information to both the first and second terminals using one DCI with respect to a bidirectional link forming the D2D link in which the first and second terminals participate, and using a D2D-RNTI common to the first and second terminals participating in the D2D link.

According to another example for achieving the object of the present invention described above, there is provided a method of operating a terminal for connection configuration and scheduling for dynamic scheduling of a D2D link, which includes: receiving connection configuration information of the D2D link; reporting a D2D buffer status of the D2D link to a base station; and receiving D2D link resource allocation information based on the D2D buffer status report.

Here, receiving the connection configuration information of the D2D link may include receiving, by the terminal, unique identifier information of a counterpart terminal or connection configuration information for the D2D link including an identifier commonly identifying the terminal itself and the counterpart terminal participating in the D2D link through radio resource control (RRC) signaling from the base station.

Here, reporting the D2D buffer status to the base station may include transmitting a Buffer Status Report (BSR) to the base station, and the BSR may be defined by extending a BSR for a cellular uplink or defined to be separate from the BSR for the cellular uplink.

Here, receiving the D2D link resource allocation information may include: receiving the resource allocation information using a separate DCI for each of transmission and reception allocation information of each of unidirectional links forming the D2D link and using a unique identifier of the terminal, or receiving the resource allocation information using D2D-RNTI(s) for each terminal.

Here, receiving the D2D link resource allocation information may include: receiving the resource allocation information using one DCI for each of unidirectional links forming the D2D link and using a unique identifier of the terminal, or receiving the resource allocation information using D2D-RNTIs of respective terminals or a D2D-RNTI common to the terminal and a counterpart terminal with respect to each D2D link.

Here, receiving the D2D link resource allocation information may include: receiving the resource allocation information using one DCI with respect to a bidirectional link forming the D2D link, and using a D2D-RNTI common to the terminal and a counterpart terminal participating in the D2D link.

According to another example for achieving the object of the present invention described above, there is provided a method of operating a base station for connection configuration and scheduling for SPS of a D2D link, which includes: configuring an SPS connection of the D2D link; activating the SPS of the D2D link; receiving a D2D buffer status report from a transmission terminal of the D2D link; receiving channel state information of the D2D link measured by a reception terminal of the D2D link; and releasing the SPS of the D2D link.

Here, configuring the SPS connection may include delivering through RRC signaling SPS connection configuration information including SPS C-RNTI information of a counterpart terminal of the D2D link or SPS-D2D-RNTI information commonly designated to the terminal and the counterpart terminal of the D2D link and at least one of an interval of SPS subframes, the number of SPS hybrid automatic repeat request (HARQ) processes, and ACK/NAK resource allocation information used for the SPS communication of the D2D link.

Here, activating the SPS may include: including resource allocation information in a separate activation message for each of transmission and reception of each of unidirectional links forming the D2D link using an SPS-C-RNTI of each of terminals participating in the D2D link or using SPS-D2D-RNTI(s) for the D2D link to provide the resource allocation information.

Here, activating the SPS may include including resource allocation information in one activation message for each of unidirectional links forming the D2D link using an SPS C-RNTI of each of terminals participating in the D2D link or using SPS-D2D-RNTI(s) common to the terminals participating in the D2D link to provide the resource allocation information.

Here, activating the SPS may include including resource allocation information in one activation message with respect to a bidirectional link forming the D2D link using an SPS-D2D-RNTI common to terminals participating in the D2D link to provide the resource allocation information.

According to another example for achieving the object of the present invention described above, there is provided a method of operating a terminal for connection configuration and scheduling for SPS of a D2D link, which includes: (a) receiving SPS connection configuration information of the D2D link from a base station; (b) receiving an SPS activation message of the D2D link from the base station; and (c) transmitting and receiving data with respect to a counterpart terminal of the D2D link using wireless resources allocated from the base station based on the SPS connection configuration information and the SPS activation message, wherein D2D buffer status information and/or channel state information of the D2D link is reported to the base station to repeat (a) to (c).

Here, receiving the SPS connection configuration information may include delivering through RRC signaling SPS connection configuration information including SPS C-RNTI information of the counterpart terminal of the D2D link or SPS-D2D-RNTI information commonly designated to the terminal and the counterpart terminal of the D2D link and at least one of an interval of SPS subframes, the number of SPS HARQ processes, and ACK/NAK resource allocation information used for SPS communication of the D2D link.

Here, receiving the SPS activation message may include including resource allocation information in a separate activation message for each of transmission and reception of each of unidirectional links forming the D2D link, including resource allocation information in one activation message for each of unidirectional links forming the D2D link, or including resource allocation information in one activation message with respect to a bidirectional link forming the D2D link using an SPS-C-RNTI of each of terminals participating in the D2D link or an SPS-D2D-RNTI common to the terminals participating in the D2D link to receive the SPS activation message.

### Advantageous Effects

The above-described scheduling method for the D2D link according to the present invention enables dynamic scheduling in subframe units and SPS for continuous data transmission even with respect to a D2D communication link.

### DESCRIPTION OF DRAWINGS

FIG. 1 is a conceptual diagram illustrating the concept of direct D2D communication.

FIG. 2 is a conceptual diagram illustrating the concept of UE relaying.

FIG. 3 is a flowchart illustrating a connection configuration and scheduling method for D2D communication in a dynamic scheduling method in accordance with an embodiment of the present invention.

FIG. 4 is a flowchart illustrating a connection configuration and scheduling method for D2D communication in an SPS method in accordance with an embodiment of the present invention.

FIG. 5 is a conceptual diagram illustrating a method of allocating D2D SPS resources per link in accordance with an embodiment of the present invention.

### MODES OF THE INVENTION

While the invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” may refer to a mobile station (MS), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, and also portable units or terminals having a combination of such functions, but the present invention is not limited thereto.

The term “base station” used herein generally denotes a fixed or moving point communicating with a terminal, and may be referred to as a Node-B, evolved Node-B (eNB), base transceiver system (BTS), access point, relay, femtocell, and other terms.

With reference to the appended drawings, preferred embodiments of the present invention will be described in detail below. To aid in understanding the present invention, like numbers refer to like elements throughout the description of the figures, and the description of the same component will not be reiterated.

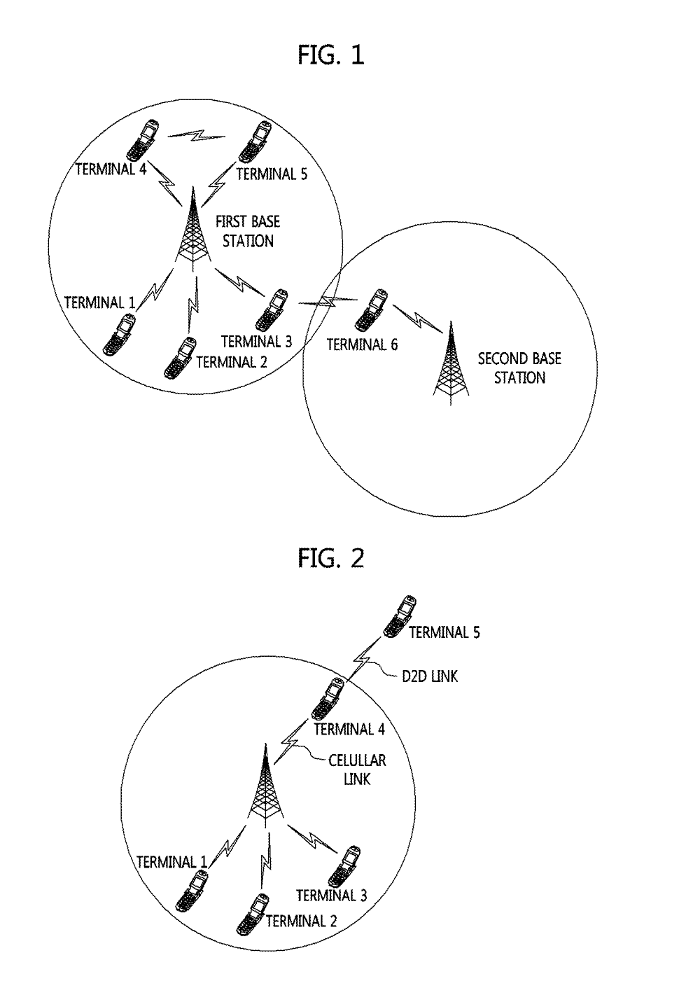

FIG. 1 is a conceptual diagram illustrating the concept of direct D2D communication at which the present invention is aimed.

Referring to FIG. 1, a cellular communication network is illustrated to include a first base station and a second base station. Here, terminal 1 to terminal 3 belonging to the cell created by the first base station perform communication through a typical connection link using the first base station, however, terminal 4 and terminal 5 belonging to the first base station perform direct data transmission and reception without allowing the data to pass through the base stations.

Various user cases may be discussed where such direct D2D communication can be effectively used. For example, the direct D2D communication may be used for a local media server or the like which provides a large amount of data (e.g., program of a rock concert, information on musicians) to attendees participating in a rock concert or the like. At this time, each terminal may connect to a serving cell to perform telephone communication and Internet access using a typical cellular link while directly transmitting and receiving the large amount of data mentioned above in the D2D communication method with respect to the local media server that corresponds to the counterpart of the D2D communication.

Meanwhile, referring to FIG. 1 again, the D2D link may be created not only between terminals having the same cell as the serving cell but also between terminals having different cells as the serving cells. For example, terminal 3 belonging to the first base station may perform the D2D communication with terminal 6 belonging to the second base station.

FIG. 2 is a conceptual diagram illustrating the concept of UE relaying communication at which the present invention is aimed.

Referring to FIG. 2, terminal 1 to terminal 3 belonging to the cell created by the first base station perform communication through a typical connection link using the first base station, however, terminal 4 belonging to the first base station acts as a relay to terminal 5, and data transmitted from the base station to terminal 5 and data transmitted from terminal 5 to the base station are relayed through terminal 4. Therefore, the overall relay is performed through a cellular link between the base station and the terminal (relay terminal) acting as the relay and a D2D link between the relay terminal and a terminal (end terminal) receiving the relaying service.

According to the UE relaying described above, transmission capacity of the terminal located at the cell boundary can be improved, and the frequency use efficiency of the entire cell can be enhanced through the frequency reuse in the D2D link.

In the embodiments of the method for direct D2D communication or UE relaying communication of the present invention to be described below, it is assumed that terminals performing the direct D2D communication and UE relaying communication belong to the same cells or different cells. Here, terminals performing the direct D2D communication and UE relaying communication are controlled by respective serving cells and perform data transmission and reception with the counterpart terminals, and adjacent cell base stations perform cooperation through information exchange if necessary.

Some or all of the terminals performing mutual communication using a D2D link may be terminals (i.e., new UEs) that can recognize terminals other than the base station as their direct communication counterparts, and some thereof may be terminals (i.e., legacy UE) that can not recognize terminals as their direct communication counterparts. The new UE is a terminal that can perform not only typical uplink transmission and downlink reception but also uplink reception and/or downlink transmission in a cellular communication system, and the legacy UE is a terminal that can only perform the uplink transmission and the downlink reception as is done in the existing UE.

Techniques to be described below include both D2D link scheduling between new UEs and D2D link scheduling between the new UE and the legacy UE.

In the present invention, the scheduling method of the D2D link for performing direct D2D communication and UE relaying communication will be described.

Meanwhile, for convenience of description, as the data scheduling method described above, two methods, that is, a method improved from an existing dynamic uplink scheduling method of 3^{rd} Generation Partnership Project Long Term Evolution (3GPP LTE) and a method improved from an SPS method, are individually described in the present invention. However, it should be noted that the technical scope of the present invention includes not only the case where the two operating methods mentioned above are separately performed but also the case where some of the technical spirit constituting each of the methods is combined and performed.

Connection Configuration and Scheduling Method for D2D Communication in Dynamic Scheduling Method

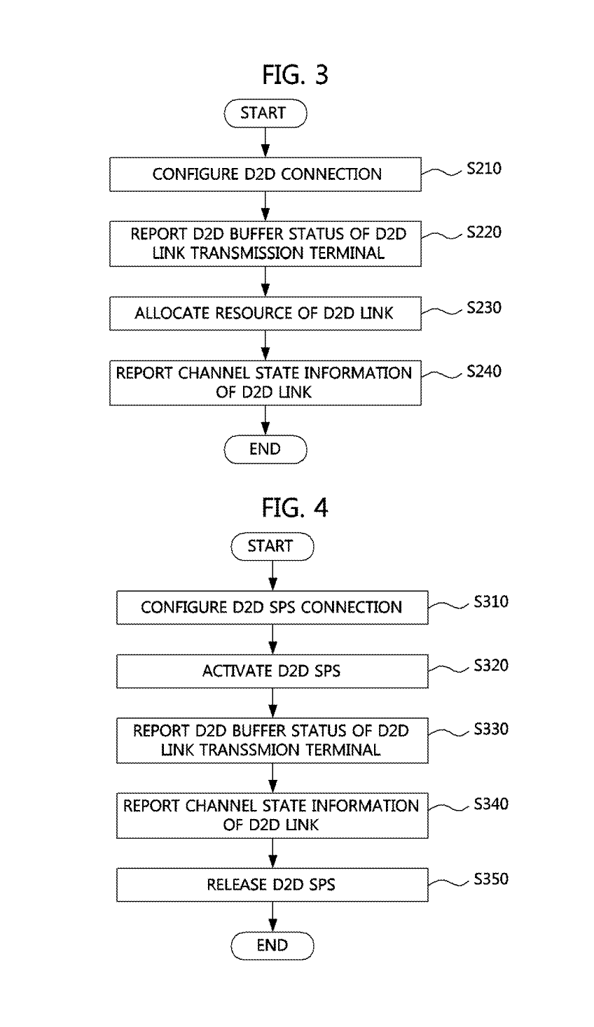

FIG. 3 is a flowchart illustrating a connection configuration and scheduling method for a D2D link in a dynamic scheduling method in accordance with an embodiment of the present invention.

Referring to FIG. 3, a connection configuration and scheduling method for a D2D link in a dynamic scheduling method according to an embodiment of the present invention may include performing connection configuration of the D2D link (S210); reporting, by a transmission terminal in the D2D link, a D2D buffer status to a base station (S220); allocating D2D resources based on the reported D2D status by the base station (S230); and measuring, by a reception terminal in the D2D link, a channel state of the D2D link and reporting the measured channel state information to the base station (S240).

In the step of performing connection configuration of the D2D link S210, the base station delivers connection configuration information for the D2D link through radio resource control (RRC) signaling to each terminal trying to perform D2D communication. In this case, the connection configuration information may include a cell-radio network temporary identifier (C-RNTI) which is a unique identifier of a counterpart terminal, a D2D-RNTI(s) that is an identifier for the D2D link and so forth, and the information to be included in the connection configuration information may be changed in accordance with a D2D resource allocation information providing method to be described later.

Step S220 of reporting the D2D buffer status of the D2D link transmission terminal for resource allocation request may be performed in a similar way to the typical method of transmitting the uplink scheduling request for the serving cell. That is, when necessary or upon transmission of cellular uplink data, the transmission terminal of the D2D link transmits, to the base station, the Buffer Status Report (BSR) (e.g., which may be defined as D2D-BSR) for D2D communication along with the corresponding data. In this case, the D2D-BSR may be defined by a separate BSR for D2D or by extending the BSR for the existing cellular uplink.

Methods of providing resource allocation information in step S230 of providing resource allocation information by the base station will be described below. Step S230 may be performed by one method or combined methods of methods described below.

A first method is to separately deliver transmission and reception allocation information to respective terminals with respect to each of unidirectional links. That is, the base station may deliver transmission allocation information and reception allocation information to respective terminals through separate Physical Downlink Control Channels (PDCCH). For example, when terminal A and terminal B form the D2D link, transmission resource allocation information is provided to terminal A using one PDCCH and reception resource allocation information with respect to the same resources is provided to terminal B using another PDCCH in the link from terminal A to terminal B. Similarly, transmission resource allocation information is provided to terminal B using one PDCCH and reception resource allocation information with respect to the same resources is provided to terminal A using another PDCCH in the link from terminal B to terminal A. This method may be used without regard to whether the two terminals forming the D2D link belong to the same cell or different cells.

This method may also be divided into a method of allocating a separate RNTI for the D2D link (which may be defined as D2D-RNTI) to discriminate between the D2D link and the cellular link and a method of differently forming a Downlink Control Information (DCI) format to discriminate between the D2D link and the cellular link without allocating the separate D2D-RNTI.

1) Method of Allocating Separate D2D-RNTI for Discrimination Between D2D Link and Cellular Link

In the existing cellular system, the C-RNTI of the terminal to receive the PDCCH is used for cyclic redundancy check (CRC) scrambling of each PDCCH, and the terminal determines that the CRC-scrambled DCI using the C-RNTI allocated to the terminal itself is the DCI delivered to the terminal itself. Therefore, one method of having the terminal determine whether the resource allocation information of the base station is about the D2D link or the cellular link is to perform CRC-scrambling using an RNTI different from the C-RNTI (which may be defined as a D2D-RNTI) with respect to the DCI for the D2D link. The information on the allocated D2D-RNTI may be configured to be delivered in advance to the D2D terminals using RRC signaling or the like.

In a detailed method, one D2D-RNTI may be allocated to each terminal. In this case, in order to have the terminal determine that the DCI is allocation information for transmission or allocation information for reception, the size of the DCI format for transmission allocation information and the size of the DCI format for reception allocation information may be configured to be different from each other. Alternatively, the same size of the DCI format may be used for the transmission and reception allocation information, and the terminal may be notified of the transmission allocation information or the reception allocation information using control information within the DCI.

In another detailed method, in order to have each terminal discriminate between transmission and reception allocation information, two D2D-RNTIs, for example, D2D-RNTI #1 and D2D-RNTI #2, may be allocated to each terminal. Here, D2D-RNTI #1 is made to scramble CRC of the DCI corresponding to the transmission allocation information, and D2D-RNTI #2 is made to scramble CRC of the DCI corresponding to the reception allocation information.

2) Method of Differently Forming DCI Formats while Sharing C-RNTI for Discrimination Between D2D Link and Cellular Link

Another method of having the terminal determine whether the resource allocation information of the base station is about the D2D link or the cellular link is to apply a format different from the DCI for the existing cellular link while using the C-RNTI allocated to the cellular link without allocating a D2D-RNTI.

In detail, when the DCI format having a different payload size from DCI formats for the existing cellular link is used as the DCI format for D2D link resource allocation, the terminal may determine that the DCI corresponds to the D2D link resource allocation or the cellular link resource allocation. On the other hand, in order not to increase the number of PDCCH blind decoding of the terminal, it may be necessary to use the DCI format with the same payload size as the existing DCI formats. To this end, control information within the DCI may be used to inform the terminal that the DCI corresponds to the D2D link resource allocation or the cellular link resource allocation.

In addition, it is necessary to have the terminal determine that the DCI for the D2D link corresponds to the transmission allocation information or the reception allocation information. To implement such discrimination, the size of the DCI format for the D2D link may be configured to be different with respect to the transmission allocation information and the reception allocation information. Another method for the same may have the same size of the DCI format for the D2D link with respect to the transmission allocation information and the reception allocation information and may use the control information within the DCI to inform the terminal that the DCI corresponds to the transmission allocation information or the reception allocation information.

A second method is to use one DCI and deliver resource allocation information on each unidirectional D2D link to two terminals at the same time. In this case, a common RNTI is allocated to the two terminals with respect to one link, and transmission allocation information and reception allocation information are delivered to the two terminals at the same time through one PDCCH which is CRC-scrambled using the common RNTI. The information on the allocated RNTI for the same may be configured to be delivered in advance to D2D terminals using RRC signaling or the like. In the link from terminal A to terminal B, information on resources are delivered to terminal A as the transmission resource allocation information, and the information on the same resources are delivered to terminal B as the reception resource allocation information. Similarly, in the link from terminal B to terminal A, information on resources are delivered to terminal B as the transmission resource allocation information, and the information on the same resources are delivered to terminal A as the reception resource allocation information.

In order to have the terminal determine that the DCI corresponds to the information for the link from terminal A to terminal B or the information for the link from terminal B to terminal A, (1) different RNTIs may be allocated to respective links to be used for CRC-scrambling of the PDCCH, (2) a common D2D-RNTI maybe allocated to two links and two DCI formats having different DCI format sizes from each other with respect to each link may be used, or (3) a common D2D-RNTI may be allocated to two links and control information within the DCI may be used for the terminal to determine that the DCI corresponds to the information for the link from terminal A to terminal B or the information for the link from terminal B to terminal A while the DCI formats of the same size are used.

In a specific embodiment using the method (1), the base station allocates two shared D2D-RNTI, that is, D2D-RNTI #1 and D2D-RNTI #2, to two terminals and uses D2D-RNTI #1 to deliver the DCI for the link from terminal A to terminal B and uses D2D-RNTI #2 to deliver the DCI for the link from terminal B to terminal A. For example, when the DCI is delivered using D2D-RNTI #1, terminal A recognizes this DCI as the transmission allocation information and terminal B recognizes this DCI as the reception allocation information. In another specific embodiment using the method (1), the base station further allocates one RNTI to each terminal in addition to its own C-RNTI. The allocated RNTI corresponds to the C-RNTI of the counterpart terminal of which the D2D link configuration is set, and must be delivered to the corresponding counterpart D2D terminal using RRC signaling or the like. Here, in order to have the terminal determine that the DCI using the C-RNTI corresponds to the D2D link or the cellular link, when the DCI format having a different payload size from DCI formats for the existing cellular link is used as the DCT format for the D2D link or when the DCI having the same payload size as the existing DCI formats is used, a control field within the DCI may be used to indicate that the DCI corresponds to the D2D link or the cellular link. In addition, each terminal recognizes the DCI for the D2D using its C-RNTI as the allocation information for the link from terminal A to terminal B (or terminal B to terminal A), and recognizes the DCI using the allocated different RNTI (i.e., the C-RNTI of the counterpart terminal) as the allocation information for the D2D link in a different direction.

A third method is to deliver allocation information of a bidirectional D2D link to two terminals at the same time. That is, one PDCCH is used to deliver the DCI including all information on the link from terminal A to terminal B and the link from terminal B to terminal A to the two terminals. The base station allocates the common RNTI (which may be defined as D2D-BSR) to the two terminals, and the PDCCH CRC-scrambled with the common RNTI is transmitted to the terminals.

After step S230, the two terminals use the resources allocated by the base station in step S230 to transmit and receive D2D data. In step S240, the reception terminal in the D2D link reports the Channel State Information of the D2D link (i.e., D2D-CSI) to the base station, upon request of the base station, periodically, or when a predetermined condition is satisfied such that the channel state is improved or deteriorated to a level equal to or higher than a predetermined level. Channel measurement of the D2D link may be performed by various methods. In one embodiment, the reception terminal may measure the D2D channel state during the data transmission and reception through the D2D link. In another embodiment, the base station may instruct the transmission terminal of the D2D link to transmit predetermined data (e.g., sounding reference signal (SRS)) suitable for measuring the D2D channel state and instruct the reception terminal of the D2D link to measure the D2D channel state and report the measurement result, and the reception terminal of the D2D link may report the measurement result to the base station in step S230.

In step 230, the base station may use the D2D-CSI reported in step S240 and the D2D-BSR reported in step S220 to calculate the transmission mode and the amount of resources required by the corresponding terminal, which may be used to allocate D2D communication resources.

Connection Configuration and Scheduling Method for D2D SPS Communication

FIG. 4 is a flowchart illustrating a connection configuration and scheduling method for D2D communication in an SPS method in accordance with an embodiment of the present invention.

Referring to FIG. 4, the D2D link scheduling method according to an embodiment of the present invention may be configured to include a step of configuring a D2D SPS connection (S310), a step of activating the D2D SPS (S320), a step of reporting the D2D-BSR to the base station by the transmission terminal of the D2D link (S330), a step of reporting the D2D-CSI to the base station by the reception terminal of the D2D link (S340), and a step of releasing the D2D SPS (S350).

Step S310 of D2D SPS connection configuration may be performed as follows. The base station delivers configuration information for the SPS-type D2D link to each terminal trying to perform the D2D SPS communication through RRC signaling. At this time, this configuration information includes an interval of SPS subframes, the number of SPS hybrid automatic repeat request (HARQ) processes, and information associated with the ACK/NAK resource allocation used for the D2D SPS communication. In addition, this configuration information may include information such as SPS C-RNTI and D2D-SPS-RNTI(s) in a similar way to the dynamic scheduling method, and the information to be included may be changed in accordance with a D2D SPS resource allocation information providing method to be described later.

After step S310 of D2D SPS connection configuration is performed, step S320 of delivering a D2D SPS activation message is performed. At this time, the activation message may be delivered using existing SPS C-RNTI or newly defined SPS-D2D-RNTI or the like through the PDCCH.

The method of delivering the D2D SPS activation message in step S320 may include three methods in the same way as the above-described method of delivering the resource allocation information in the dynamic scheduling D2D communication method. A first method is to separately deliver transmission and reception D2D SPS activation messages to respective terminals with respect to each unidirectional link. That is, the base station may separately deliver the transmission and reception D2D SPS activation messages of one link to respective terminals through respective PDCCHs. A specific method for the same is the same as the first method of allocating the resource allocation information in the dynamic scheduling D2D communication method, that is, the method of separately delivering the transmission and reception allocation information to the respective terminals except that the C-RNTI and the D2D-RNTI are changed to SPS C-RNTI and D2D-SPS-RNTI, respectively.

A second method is to deliver one message for transmission and reception D2D SPS activation to two terminals for each unidirectional D2D link. That is, a common RNTI for one link is allocated to the two terminals, which is then used to deliver the transmission and reception D2D SPS activation information to the two terminals through one PDCCH at the same time. A specific method for the same is the same as the first method of allocating the resource allocation information in the dynamic scheduling D2D communication method, that is, the method of using one DCI to deliver the resource allocation information for each unidirectional D2D link to the two terminals at the same time except that the C-RNTI and the D2D-RNTI are changed to SPS C-RNTI and D2D-SPS-RNTI, respectively.

A third method is to deliver an SPS activation message of a bidirectional D2D link to two terminals at the same time. That is, the DCI including all D2D SPS activation information on the link from terminal A to terminal B and the link from terminal B to terminal A is delivered to the two terminals using one PDCCH. The base station allocates one common RNTI (which may be defined as D2D-SPS-RNTI) to the two terminals, and the common RNTI is used to deliver the activation message of the bidirectional D2D link to the terminals through one PDCCH.

Allocation of the D2D SPS resources is determined by the combination of the RRC signaling in step S310 of D2D SPS connection configuration and the PDCCH of step S320 of D2D SPS activation. That is, basic information such as a D2D SPS subframe interval to be delivered in step S310 of D2D SPS connection configuration and information such as the position and amount of the allocation resources, transmission modes, or the like within the subframe to be delivered in step S320 of D2D SPS activation must be combined to complete the entire D2D SPS resource allocation information.

Resources may be independently allocated to two unidirectional D2D links, or may be allocated in a mutually-associated form.

In the method of independently allocating resources to the two unidirectional D2D links, a parameter such as an SPS subframe interval is set in the D2D SPS connection configuration step, and independent resource allocation information is additionally delivered to the terminals per D2D link in the D2D SPS activation step. The position of the allocation resource at the frequency axis is determined by the resource allocation information within the DCI included in the activation PDCCH.

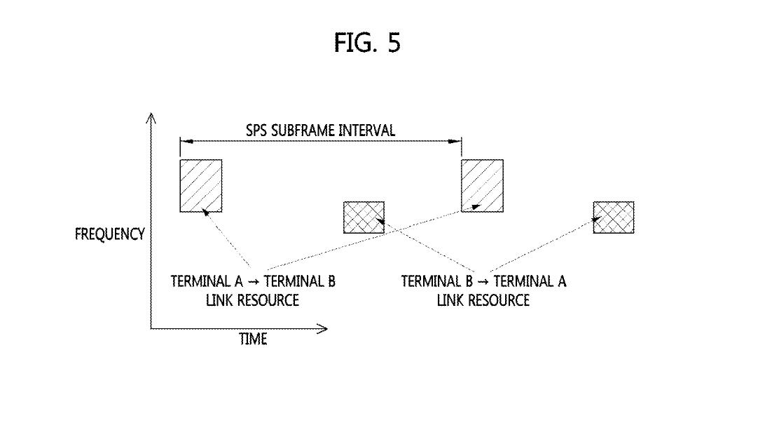

FIG. 5 is a conceptual diagram illustrating a method of allocating D2D SPS resources per link in accordance with an embodiment of the present invention, and resources of different sizes and different positions may be allocated to two D2D links in the frequency and time resource domains as shown in FIG. 5. The position of the allocation resource at the time axis is determined by the time at which the activation PDCCH is received and the SPS subframe interval included in the D2D SPS connection configuration information. For example, a first resource is allocated at the n^{th} subframe from the subframe at which the PDCCH is received, and the remaining allocation resources are periodically allocated at a subframe interval corresponding to the value of “SPS subframe interval.”

Next, the method of allocating resources in a form in which two unidirectional D2D links are associated with each other may be applied when the third method among the methods of delivering the D2D SPS activation messages, that is, the method of delivering the SPS activation messages of a bidirectional D2D link to the two terminals at the same time, is used. Parameters such as “SPS subframe interval,” “inter-link frequency offset” and/or “inter-link time offset” are set in the D2D SPS connection configuration step, and resource allocation information commonly applied to both D2D links is included and additionally delivered to the terminals in the D2D SPS activation step. The parameters such as “inter-link frequency offset” and/or “inter-link time offset” may be delivered through the PDCCH in the D2D SPS activation step rather than the SPS connection configuration step. In addition, different amounts of allocation resources for two unidirectional links may be delivered through the PDCCH in the D2D SPS activation step. The position of the allocation resource per link at the frequency axis is determined by the parameter of “inter-link frequency offset” (when it is present) and the resource allocation information within the DCI included in the D2D SPS activation PDCCH. The position of the allocation resource at the time axis is determined by the parameter of “inter-link time offset” (when it is present) and the “SPS subframe interval” of the SPS configuration information. For example, a first resource of the link from terminal A to terminal B is allocated at the n^{th} subframe from the subframe at which the PDCCH is received, and the remaining allocation resources of the link from terminal A to terminal B are periodically allocated at a subframe interval corresponding to the value of “SPS subframe interval.” In the resources for the link from terminal B to terminal A, a first resource is allocated at a subframe that is offset by the “inter-link offset” value from the first resource of the link from terminal A to terminal B, and the remaining allocation resources of the link from terminal B to terminal A are periodically allocated at a subframe interval corresponding to the value of “SPS subframe interval.”

After the D2D SPS activation step S320, two terminals use the resources semi-persistently and periodically allocated by the base station in step S320 to transmit and receive D2D data. In addition, the transmission terminal of the D2D link, when necessary or upon transmission of cellular uplink data, reports the D2D-BSR along with the corresponding data to the base station in step S330. At this time, the D2D-BSR may be defined as a separate BSR for D2D or may be defined by extending the BSR for the existing cellular uplink.

The reception terminal in the D2D link reports the measured D2D-CSI of the D2D link to the base station, upon request of the base station, periodically, or when a predetermined condition is satisfied such that the channel state is improved or deteriorated to a level equal to or higher than a predetermined level in step S340. Channel measurement of the D2D link may be performed by various methods. In one embodiment, the reception terminal may measure the D2D channel state during the periodic data transmission and reception through the D2D link. In another embodiment, the base station may notify one of the two terminals of information associated with transmission of an SRS for measuring the uplink channel state by the counterpart terminal, that is, period, offset, transmission bandwidth and position, SRS sequence and transmission power and so forth, and the terminal that has received the corresponding SRS using the information may measure the reception quality of the corresponding D2D link. In another embodiment, the base station may instruct the transmission terminal of the D2D link to transmit an SRS for measuring the D2D link channel state or predetermined data suitable for measuring the D2D link channel state and notify the reception terminal of the D2D link of information associated with the transmission, and the reception terminal of the D2D link may measure reception quality of the corresponding D2D link.

The base station uses the D2D-BSR reported in step S330, the D2D-CSI reported in step S340, and so forth to determine whether or not the current D2D SPS connection configuration information (e.g., SPS subframe interval) or contents of the SPS activation message (e.g., amount of periodic allocation resource and transmission mode) need to be changed. When it is determined that the information or the contents need to be changed, the base station delivers the changed configuration information for an SPS-type D2D link to each terminal performing the D2D SPS communication through RRC signaling to reconfigure the D2D SPS connection in step S310 or delivers the D2D SPS activation message including the changed contents to the corresponding terminals in step S320.

The D2D SPS release step S350 may be performed in the D2D SPS communication activated after the D2D SPS activation message is delivered. That is, the base station monitors the D2D-BSR reported by the transmission terminal of the D2D SPS link and transmits the D2D SPS release message through the PDCCH to release the D2D SPS when the D2D-BSR reports “empty” a predetermined number of times or more, for a predetermined period of time or more, or when the D2D SPS release request is transmitted from the transmission terminal. At this time, the method of delivering the D2D SPS release message may be changed in accordance with the method of delivering the D2D SPS activation message in step S320.

When the first method, that is, the method of separately delivering the transmission and reception activation messages for each unidirectional link to the respective terminals, is applied, the base station may separately deliver transmission and reception D2D SPS release messages for each unidirectional link to the respective terminals through respective PDCCHs. In a specific method for the same, when one D2D-SPS-RNTI is allocated to each terminal, the DCI formats may be configured to discriminate between the transmission and reception D2D SPS releases. When D2D-SPS-RNTI #1 and D2D-SPS-RNTI #2 for transmission and reception D2D SPS allocation are allocated to each terminal, the base station may use the same RNTIs to deliver the D2D SPS release message to the terminal. When the method of discriminating between the cellular SPS and D2D SPS and between the transmission and reception D2D SPS activation messages using different DCI formats while sharing the C-RNTI allocated to the cellular link is applied, different DCI formats may be configured in the same way as the applied method even for the D2D SPS release. Here, having the DCI formats with different configurations means that the DCI format size is changed or the control information within the DCI is provided as described above.

Next, when the second method, that is, the method of delivering one message for transmission and reception D2D SPS activation for each unidirectional D2D link to two terminals, is applied, the base station may use a common RNTI for one link to deliver the D2D SPS release message for the corresponding link to the two terminals. In a specific method for the same, when D2D-SPS-RNTI #1 and D2D-SPS-RNTI #2 are allocated for each link, the base station may use the same RNTIs to deliver the D2D SPS release message to the two terminals. When the C-RNTI of the counterpart terminal is additionally allocated to each terminal for D2D SPS, different DCI formats are applied for discriminating between the cellular link and the D2D link, and each C-RNTI is mapped to one unidirectional D2D link, the base station may deliver the D2D SPS release message to the two terminals in the same way even for the D2D SPS release.

Last, when the third method, that is, the method of using one D2D-SPS-RNTI to deliver the SPS activation message of the bidirectional D2D link to the two terminals at the same time, is applied, the base station uses the same D2D-SPS-RNTI to deliver the SPS release message of the bidirectional D2D link to the terminals through one PDCCH.

Connection Configuration and Scheduling Method when One Side of D2D Link is Legacy UE

The D2D connection configuration and scheduling methods between new UEs have been described up to now; however, D2D connection configuration and scheduling may also be applied when one side of the two terminals performing communication using the D2D link is a legacy UE.

When one side of the two terminals is the legacy UE, in the D2D connection configuration step S210, the existing connection configuration method for a cellular link is applied as is to the D2D connection configuration for the legacy UE, and the connection configuration method for the dynamic scheduling type D2D communication is applied to the D2D connection configuration for the new UE.

In addition, when one side of the two terminals is the legacy UE, in the D2D SPS connection configuration step S310, the existing connection configuration method for a cellular link is applied as is to the D2D SPS connection configuration for the legacy UE, and the connection configuration method for the D2D SPS communication is applied to the D2D SPS connection configuration for the new UE.

Scheduling of the D2D link when one side of the two terminals is the legacy UE may also include two methods such as the dynamic scheduling method and the SPS method.

(1) Dynamic Scheduling Method

In step S220, when the terminal requesting the D2D communication resource allocation from the base station is the new UE, the D2D-BSR is transmitted to request the downlink transmission resource allocation for the D2D link, and when the terminal requesting the resource allocation is the legacy UE, the existing BSR is transmitted to request the uplink transmission resource allocation. This is because the D2D link transmission is possible only through the uplink and the D2D link reception is also possible only through the downlink in the case of the legacy UE.

Next, in order to allocate the resources of the D2D link in step S230, the base station may provide the legacy UE with uplink or downlink resource allocation information through different PDCCHs in the same way as the existing cellular link in the case of the legacy UE. On the other hand, the first method of the methods of allocating resources for the dynamic D2D scheduling described above, that is, the method of separately delivering the transmission and reception allocation information to the respective terminals with respect to each unidirectional link, may be applied to the case of the new UE.

Last, in step S240, the new UE reports to the base station the CSI of the D2D link from the legacy UE to the new UE (D2D-CSI) upon request of the base station, periodically, or when a predetermined condition is satisfied such that the channel state is improved or deteriorated to a level equal to or higher than a predetermined level. In order to measure the D2D channel for reporting, the base station may instruct the legacy UE to transmit the uplink SRS and instruct the new UE to measure the SRS and report the measurement result, and the new UE reports the measurement result to the base station in the step S240.

(2) SPS Method

In step S320, for the SPS activation of the D2D link, the base station may provide the uplink or downlink SPS activation message to the legacy UE through different PDCCHs in the same way as the existing cellular link. On the other hand, the first method of the methods of allocating resources for D2D SPS described above, that is, the method of separately delivering the transmission and reception D2D SPS activation messages with respect to each unidirectional link to the respective terminals, may be applied for the new UE.

In step S330, in order to have the transmission terminal report the D2D buffer status, the D2D-BSR is transmitted when the terminal is the new UE and the existing BSR is transmitted when the terminal is the legacy UE.

In step S340, the new UE reports to the base station the CSI of the D2D link from the legacy UE to the new UE (D2D-CSI) upon request of the base station, periodically, or when a predetermined condition is satisfied such that the channel state is improved or deteriorated to a level equal to or higher than a predetermined level. In order to measure the D2D channel for reporting, the base station may instruct the legacy UE to transmit the uplink SRS and instruct the new UE to measure the SRS and report the measurement result, and the new UE reports the measurement result to the base station in step S340.

Last, in order to release the D2D SPS in step 350, the base station delivers the existing SPS release message to the legacy UE, and the first method of the methods of releasing the D2D SPS described above, that is, the method of separately delivering the transmission and reception D2D SPS release messages with respect to each unidirectional link to respective terminals through respective PDCCHs, is applied for the new UE.

While the present invention has been described above with reference to the above-described embodiments, it will be understood by those skilled in the art that that various changes, substitutions and alterations may be made herein without departing from the spirit and scope of the invention as defined in the following claims.

1. A method of operating a base station for connection configuration and scheduling for dynamic scheduling of a device-to-device (D2D) link, the method comprising:
performing connection configuration of the D2D link;
receiving a D2D buffer status report from a first terminal that is a transmission terminal in the D2D link;
allocating D2D link resources based on the D2D buffer status report and providing resource allocation information; and
receiving channel state information of the D2D link measured by a second terminal that is a reception terminal in the D2D link.

2. The method of claim 1, wherein providing the D2D link resource allocation information includes:
providing the resource allocation information using separate Downlink Control Information (DCI) for each of transmission and reception allocation information of each of unidirectional links forming the D2D link in which the first and second terminals participate, and using unique identifiers of the respective first and second terminals, or
providing the resource allocation information using a D2D-radio network temporary identifier (RNTI) for the D2D link.

3. The method of claim 2, wherein providing the resource allocation information using the unique identifiers of the respective first and second terminals includes changing a payload size of the DCI or including discrimination information within the DCI in order to determine whether the resource allocation information is one for the D2D link or one for the cellular link and whether the resource allocation information is transmission allocation information or reception allocation information for the D2D link.

4. The method of claim 2, wherein providing the resource allocation information using the D2D-RNTI for the D2D link includes varying the D2D-RNTI with respect to each of the transmission allocation information and the reception allocation information, changing a payload size of the DCI, or including discrimination information within the DCI in order to determine whether the resource allocation information is transmission allocation information or reception allocation information.

5. The method of claim 1, wherein providing the D2D link resource allocation information includes providing the resource allocation information by using one DCI for each of unidirectional links forming the D2D link in which the first and second terminals participate, and by providing two D2D-RNTIs common to the first and second terminals participating in the D2D link to each of the first and second terminals, providing one D2D-RNTI common to the first and second terminals participating in the D2D link to each of the first and second terminals and changing a payload size of the DCI, or including discrimination information within the DCI in order to determine to which direction the D2D link resource allocation information is directed between two D2D links.

6. The method of claim 1, wherein providing the D2D link resource allocation information includes providing the resource allocation information to both the first and second terminals using one DCI with respect to a bidirectional link forming the D2D link in which the first and second terminals participate, and using a D2D-RNTI common to the first and second terminals participating in the D2D link.

7. A method of operating a terminal for connection configuration and scheduling for dynamic scheduling of a D2D link, the method comprising:
receiving connection configuration information of the D2D link;
reporting a D2D buffer status of the D2D link to a base station; and
receiving D2D link resource allocation information based on the D2D buffer status report.

8. The method of claim 7, wherein receiving the connection configuration information of the D2D link includes receiving, by the terminal, unique identifier information of a counterpart terminal or connection configuration information for the D2D link including an identifier commonly identifying the terminal itself and the counterpart terminal participating in the D2D link through radio resource control (RRC) signaling from the base station.

9. The method of claim 7, wherein reporting the D2D buffer status to the base station includes transmitting a Buffer Status Report (BSR) to the base station, and
the BSR is defined by extending a BSR for a cellular uplink or is defined to be separate from the BSR for the cellular uplink.

10. The method of claim 7, wherein receiving the D2D link resource allocation information includes:
receiving the resource allocation information using a separate DCI for each of transmission and reception allocation information of each of unidirectional links forming the D2D link, and using a unique identifier of the terminal, or
receiving the resource allocation information using D2D-RNTI(s) for each terminal.

11. The method of claim 7, wherein receiving the D2D link resource allocation information includes:
receiving the resource allocation information using one DCI for each of unidirectional links forming the D2D link, and using a unique identifier of the terminal, or
receiving the resource allocation information using D2D-RNTIs of respective terminals or a D2D-RNTI common to the terminal and a counterpart terminal with respect to each D2D link.

12. The method of claim 7, wherein receiving the D2D link resource allocation information includes receiving the resource allocation information using one DCI with respect to a bidirectional link forming the D2D link, and using a D2D-RNTI common to the terminal and a counterpart terminal participating in the D2D link.

13. A method of operating a base station for connection configuration and scheduling for SPS of a D2D link, the method comprising:
configuring an SPS connection of the D2D link;
activating the SPS of the D2D link;
receiving a D2D buffer status report from a transmission terminal of the D2D link;
receiving channel state information of the D2D link measured by a reception terminal of the D2D link; and
releasing the SPS of the D2D link.

14. The method of claim 13, wherein configuring the SPS connection includes delivering through RRC signaling SPS connection configuration information including SPS C-RNTI information of a counterpart terminal of the D2D link or SPS-D2D-RNTI information commonly designated to the terminal and the counterpart terminal of the D2D link and at least one of an interval of SPS subframes, the number of SPS hybrid automatic repeat request (HARQ) processes, and ACK/NAK resource allocation information used for the SPS communication of the D2D link.

15. The method of claim 13, wherein activating the SPS includes including resource allocation information in a separate activation message for each of transmission and reception of each of unidirectional links forming the D2D link using an SPS-C-RNTI of each of terminals participating in the D2D link or using SPS-D2D-RNTI(s) for the D2D link to provide the resource allocation information.

16. The method of claim 13, wherein activating the SPS includes including resource allocation information in one activation message for each of unidirectional links forming the D2D link using an SPS C-RNTI of each of terminals participating in the D2D link or using SPS-D2D-RNTI(s) common to the terminals participating in the D2D link to provide the resource allocation information.

17. The method of claim 13, wherein activating the SPS includes including resource allocation information in one activation message with respect to a bidirectional link forming the D2D link using an SPS-D2D-RNTI common to terminals participating in the D2D link to provide the resource allocation information.

18. A method of operating a terminal for connection configuration and scheduling for SPS of a D2D link, the method comprising:
(a) receiving SPS connection configuration information of the D2D link from a base station;
(b) receiving an SPS activation message of the D2D link from the base station; and
(c) transmitting and receiving data with respect to a counterpart terminal of the D2D link using wireless resources allocated from the base station based on the SPS connection configuration information and the SPS activation message,
wherein D2D buffer status information and/or channel state information of the D2D link is reported to the base station to repeat (a) to (c).

19. The method of claim 18, wherein receiving the SPS connection configuration information includes delivering through RRC signaling SPS connection configuration information including SPS C-RNTI information of the counterpart terminal of the D2D link or SPS-D2D-RNTI information commonly designated to the terminal and the counterpart terminal of the D2D link and at least one of an interval of SPS subframes, the number of SPS HARQ processes, and ACK/NAK resource allocation information used for SPS communication of the D2D link.

20. The method of claim 18, wherein receiving the SPS activation message includes including resource allocation information in a separate activation message for each of transmission and reception of each of unidirectional links forming the D2D link, including resource allocation information in one activation message for each of unidirectional links forming the D2D link, or including resource allocation information in one activation message with respect to a bidirectional link forming the D2D link using an SPS-C-RNTI of each of terminals participating in the D2D link or an SPS-D2D-RNTI common to the terminals participating in the D2D link to receive the SPS activation message.
